(19) United States
(12) Patent Application Publication
(10) Pub. No.: US 2010/0088721 A1
(43) Pub. Date: Apr. 8, 2010

(54) IPTV receiver and method for changing channel of IPTV receiver

(76) Inventors: Ho Taek Hong, Seoul (KR); Jong Yeul Suh, Seoul (KR); Joon Hui Lee, Seoul (KR); Kyung Ho Kim, Seoul (KR)

Correspondence Address: MCKENNA LONG & ALDRIDGE LLP, 1900 K STREET, NW, WASHINGTON, DC, 20006, US

(21) Appl. No.: 12/588,166

(22) Filed: Oct. 6, 2009

(30) Foreign Application Priority Data
Oct. 8, 2008 (KR) 10-2008-0098477

(51) Int. Cl. H04N 5/445; H04N 7/173

(52) U.S. Cl. 725/38; 725/110

(57) ABSTRACT

A method of changing a channel in an Internet Protocol Television is disclosed. The method includes receiving Fast Channel Change information of Audio/Video streams associated with an internet broadcast service of at least one channel, pre-storing the Fast Channel Change information of the A/V streams, setting a display and codec configuration for a new channel using the pre-stored Fast Channel Change information, receiving the Audio/Video streams associated with the internet broadcast service of the new channel, and displaying Audio/Video streams of the new channel.

This application claims the benefit of Korean Application No. 10-2008-0098477, filed on Oct. 8, 2008, which is hereby incorporated by reference.

### BACKGROUND OF THE INVENTION

1. Field of the Invention

The present invention relates to a digital broadcast system, and more particularly, to an Internet Protocol Television (Hereinafter referred to IPTV) receiver, and a method of changing a channel of an IPTV receiver. Although the present invention is suitable for a wide scope of applications, it is particularly suitable for an IPTV receiver.

2. Discussion of the Related Art

Along with the development of digital broadcasting based on digital foundation, home internet network is being used for services including viewing real-time broadcasting, Contents on Demand (Hereinafter referred to CoD), news, or playing games. Before such development, a broadcast receiver generally received contents provided by the broadcasting companies through terrestrial broadcaster, cable System Operator (Hereinafter referred to SO) or Multiple System Operator (Hereinafter referred to MSO), or satellite broadcaster.

An IPTV is an example of a digital broadcast receiver able to receive various contents using the internet network. An IPTV provides different information services, including moving pictures, news, and contents, among others. The internet network, which is based on Internet Protocol (Hereinafter referred to IP), can be transmitted through fiber-optic cable, coaxial cable, Fiber To The Home (Hereinafter referred to FTTH), telephone line, or wireless system.

Unlike terrestrial broadcast, by using the internet network, two-way communication is possible, enabling the users to choose the contents and the time of viewing the broadcast program.

Despite all the benefits of an IPTV receiver, the time involved in switching a channel takes substantially longer due to the time it takes in receiving the display information and codec information, and determining the display and codec configurations in order to display a new channel according to the configurations.

### SUMMARY OF THE INVENTION

Accordingly, the present invention is directed to an IPTV receiver that substantially obviates one or more problems due to limitations and disadvantages of the related art.

An object of the present invention is to provide a method of changing a channel of an IPTV receiver by reducing the time involved in switching a channel.

Another object of the present invention is to provide a method of changing a channel of an IPTV receiver by reducing the time involved in switching a channel by reducing the time it takes to configure for displaying.

A further object of the present invention is to provide an IPTV receiver that will reduce the time involved in switching a channel.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of changing a channel in an IPTV receiver that includes receiving Fast Channel Change (Hereinafter referred to FCC) information of Audio/Video (Hereinafter referred to A/V) streams associated with an internet broadcast service of at least one channel, the FCC information including display information and codec information of the A/V streams, pre-storing the FCC information of the A/V streams, receiving a channel change request, setting display configuration for the new channel using the pre-stored display information when the channel change request is received, setting codec configuration for the new channel using the pre-stored codec information, receiving A/V streams associated with the internet broadcast service of the new channel after the display and codec configuration is set, and displaying A/V streams of the new channel according to the display configuration.

In another aspect of the present invention, a method of changing a channel in an IPTV receiver that includes receiving the FCC information of the A/V streams associated with an internet broadcast service of the new channel when a channel change request is received, the FCC information including display information and codec information, setting a display configuration for the new channel using the display information, setting a codec configuration for the new channel using the codec information, receiving the A/V streams associated with the internet broadcast service of the new channel after the display and codec configuration is set, and displaying A/V streams of the new channel according to the display configuration.

In another aspect of the present invention, an IPTV receiver includes a receiving unit for receiving FCC information of A/V streams associated with an internet broadcast service of at least one channel, the FCC information including display and codec information of the A/V streams, a storage for pre-storing the display and codec information, a display processor for processing the A/V streams, where the display configuration of the display processor for a new channel is set using the pre-stored display information when a channel change request is received from an end user, the new channel being one of the at least one channel, a decoder for decoding the A/V streams, where a codec configuration of the decoder for the new channel is set using the pre-stored codec information when the channel change request is received from the end user, the receiving unit further receives A/V streams of associated with an internet broadcast service of the new channel after the display and codec configurations are set, and a display for displaying the AV streams of the new channel according to the display and codec configurations.

In a further aspect of the present invention, an IPTV receiver includes a receiving unit for receiving the FCC information of A/V streams associated with an internet broadcast service of a new channel when a channel change is requested from an end user, the FCC information including display information and codec information of the A/V streams, a display processor for processing the A/V streams, where a display configuration of the display processor for a new channel is set using the display information, a decoder for decoding the A/V streams, where a codec configuration of the decoder for the new channel is set using the codec information, the receiving unit further receives the A/V streams of associated with an internet broadcast service of the new channel after the display and codec configurations are set, and a display for displaying the AV streams of the new channel according to the display and codec configurations.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates an overview of an IPTV system according to an embodiment of the present invention;

FIG. 2 illustrates a multicast method of an IPTV system according to an embodiment of the present invention;

FIG. 3 illustrates a unicast method of an IPTV system according to an embodiment of the present invention;

FIG. 4 illustrates a block diagram of an IPTV server configuration according to an embodiment of the present invention;

FIG. 5 illustrates a block diagram of the FCC information structure according to an embodiment of the present invention;

FIGS. 6A and 6B illustrate a XML schema of the FCC information structure illustrated in FIG. 5;

FIG. 7 is an exemplary diagram of a feature parameters object syntax according to the FCC information structure illustrated in FIG. 5;

FIG. 8 illustrates a block diagram of an IPTV receiver configuration according to an embodiment of the present invention;

FIG. 9 is a flowchart illustrating a method for changing channel of an IPTV receiver according to the first embodiment of the present invention;

FIG. 10 is a flowchart illustrating a method for changing channel of an IPTV receiver according to the second embodiment of the present invention;

FIG. 11 is a flowchart illustrating the general steps in changing channel of an IPTV server and an IPTV receiver;

FIG. 12 is a flowchart illustrating the steps in changing channel of an IPTV server and an IPTV receiver according to the first embodiment of the present invention; and

FIG. 13 is a flowchart illustrating the steps in changing channel of an IPTV server and an IPTV receiver according to the second embodiment of the present invention.

### DETAILED DESCRIPTION OF THE INVENTION

Reference will now be made in detail to the embodiments of the present invention, examples of which are illustrated in the accompanying drawings. Wherever possible, the same reference numbers will be used throughout the drawings to refer to the same or like parts.

An IPTV system is an example that uses the internet network to provide various contents, and it can generally be divided into server and network, and client.

IPTV server may have multifunctional servers including Service Discovery & Selection (Hereinafter referred to SD&S) server, Streaming server, Contents Guide Information server, Customer Information server, Payment Information server.

The Streaming server transmits to end users the stored and encoded movie data in the server, such as Moving Picture Experts Group (Hereinafter referred to MPEG) 2 and MPEG4, through the network. Real-time Transport Protocol (Hereinafter referred to RTP) and Real-time Transport Control Protocol (Hereinafter referred to RTCP) are one of the protocols used to transmit the data.

If Real-Time Streaming Protocol (Hereinafter referred to RTSP) is used to transmit the data as mentioned above, it is possible to control the playback of the movie streaming to some extent using a function called network Trick Play having functions such as Pause, Replay, and Stop. Other real-time transport protocol can also be used depending upon the embodiment.

The Contents Guide Information server provides information about the various contents of the above data. The contents guide information includes information about the contents corresponding to EPG (Electronic Program Guide) information. The Contents Guide Information server stores the content guide information and provides such data to the receiver.

The SD&S server provides connection and playback information about the different contents, such as broadcast, CoD, and game, to the receiver.

A network system may have an internet-based network and a gateway. The internet network, based on IP, can be used in different networks, such as the fiber-optical cable, coaxial cable, FTTH, telephone line, and wireless. The gateway transmits not only the general data, but it also performs Multicast group management and Quality of Service (QoS) group management using the protocols such as Internet Group Management Protocol (Hereinafter referred to IGMP).

The term “receiver” used in the present invention is directed to IPTV receiver that is used to receive and handle the data transmitted through the internet network. However, the “receiver” is not limited to IPTV receiver, but it can also be directed to IPTV Set Top, Homenet Gateway, or IPTV embedded TV, among others.

In case of a hybrid-type IPTV system, it can provide different internet contents as well as the existing broadcasting contents. More specifically, the hybrid-type IPTV system can provide terrestrial broadcast, cable broadcast, satellite broadcast, private broadcast, and also various internet image and data contents to the end users. Moreover, the contents described above can be provided in real-time and also upon on demand.

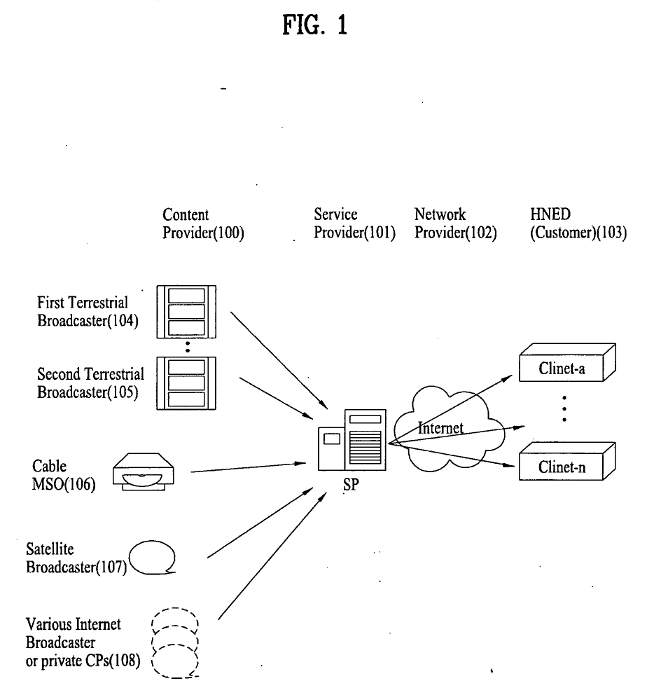

FIG. 1 illustrates a general overview of IPTV system.

Looking at IPTV system in point of the contents service provider's view, IPTV system can be divided into four terminals: Content Provider (Herein after referred to CP) 100, Service Provider (Hereinafter referred to SP) 101, Network Provider (Hereinafter referred to NP) 102, and Home Network End Device (HNED) or Customer 103.

The CP produces and provides different contents. CP, for example, as shown in FIG. 1, can be terrestrial broadcast, cable SO or MSO, satellite broadcaster, or internet broadcaster.

The SP provides the contents mentioned above by packetizing the contents service. For example, as shown in FIG. 1, the SP packetizes the broadcast from a First Terrestrial Broadcaster 104, a Second Terrestrial Broadcaster 105, Cable MSO 106, Satellite Broadcaster 107, and Various Internet Broadcaster or private CPs 108 and provides it to the end users.

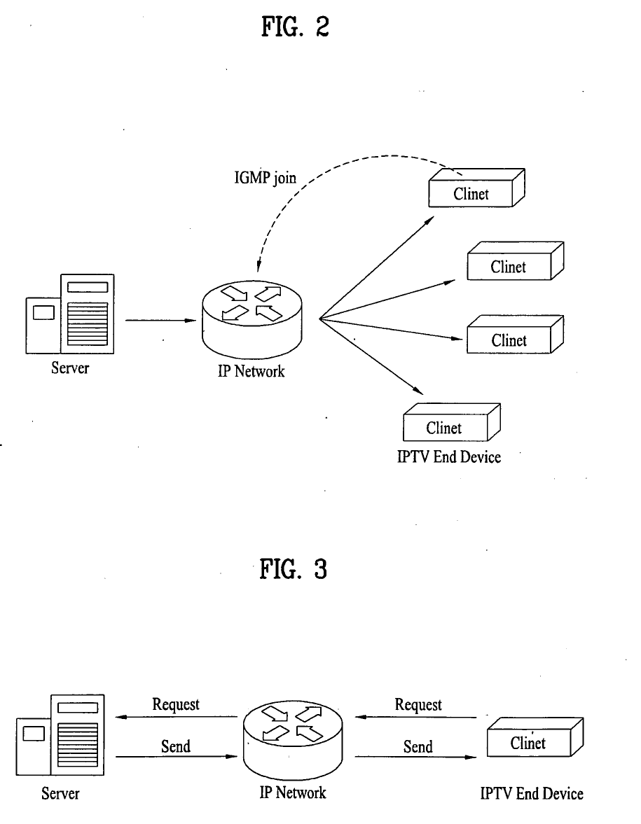

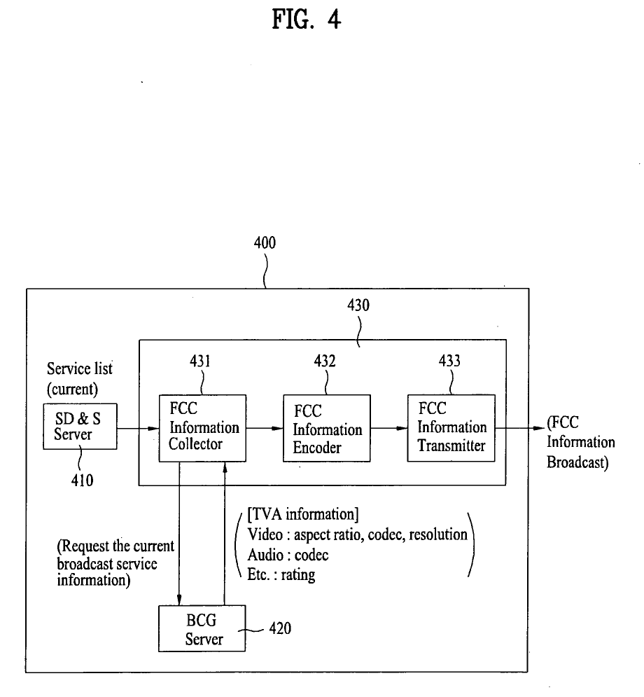

The SP mentioned above, provides the service to the end users by using a unicast or a multicast method of transmission. FIG. 2 and FIG. 3 illustrate the multicast and unicast methods. In the multicast method, the data is transmitted to a plurality of receivers in a specifically identified group. For example, the server is able to transmit the stored data to multiple receivers at once. In order to register for the multicast, IGMP may be used. In the unicast method, there is one transmitter and one receiver, and the data transmitted between the transmitter and the receiver is 1:1. For example, in the unicast method, if the receiver requests data from the server, the server will provide the data by transmitting it to the receiver.

The NP provides the network in order to provide the services mentioned above to the end users. The end users can build a Home Network End Device (HNED) to receive the services described above.

In order to protect the contents that is being transmitted in IPTV system, Conditional Access and Content Protection can be used. Examples of limiting transmission and contents protection are using Cable Card or Downloadable Conditional Access System (DCAS).

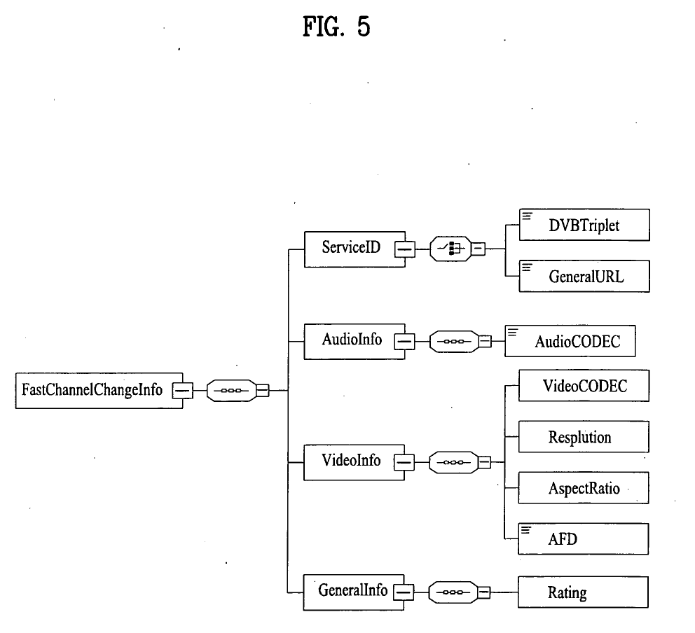

FIG. 4 illustrates a block diagram of IPTV server configuration according to an embodiment of the present invention. The methods of generating and transmitting the data for a fast channel change will be described in detail with reference to FIG. 4. The IPTV server illustrated in FIG. 4 can replace or be incorporated with the servers illustrated in FIGS. 2 and 3.

IPTV server 400, for example, includes SD&S server 410, Broadband Content Guide (BCG) server 420, and FCC information generator 430. It is also possible to add, modify, or delete the configuration of IPTV server. In addition, FCC information generator 430 includes FCC information collector 431, FCC information encoder 432, and FCC information transmitter 433.

FCC information collector 431 receives the current internet broadcast service list from SD&S 410. Further, FCC information collector 431 requests to BCG server 420 the information needed to decode and display A/V streams corresponding to the current internet broadcasting service. BCG server 420, with the request of FCC information collector 431, transmits the information needed to decode and display A/V streams to FCC information collector 431. FCC information collector 431 for example, can receive the information needed to decode and display A/V streams from TV-Anytime metadata of BCG server 420.

FCC information encoder 432 codes FCC information received from FCC information collector 431 into binary or XML format and FCC information transmitter 433 transmits coded FCC information to IPTV receiver. FCC information includes information regarding decoding and displaying A/V streams from one or more channel of the internet broadcast service. Further, FCC information includes information regarding identifying the internet broadcast service, audio codec, video codec and resolution, and aspect ratio.

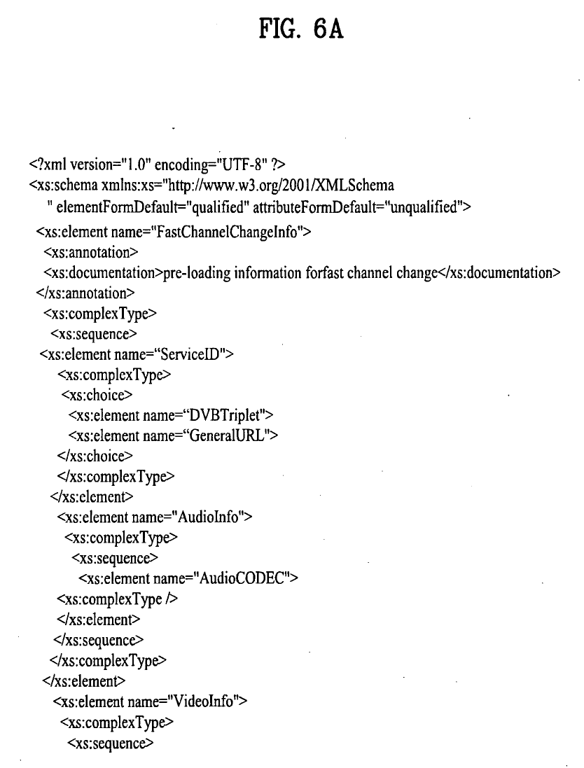

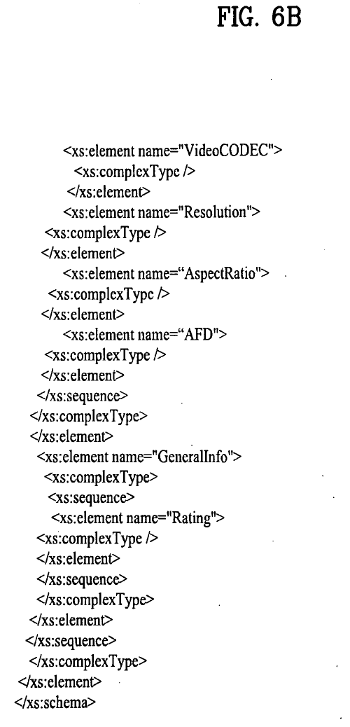

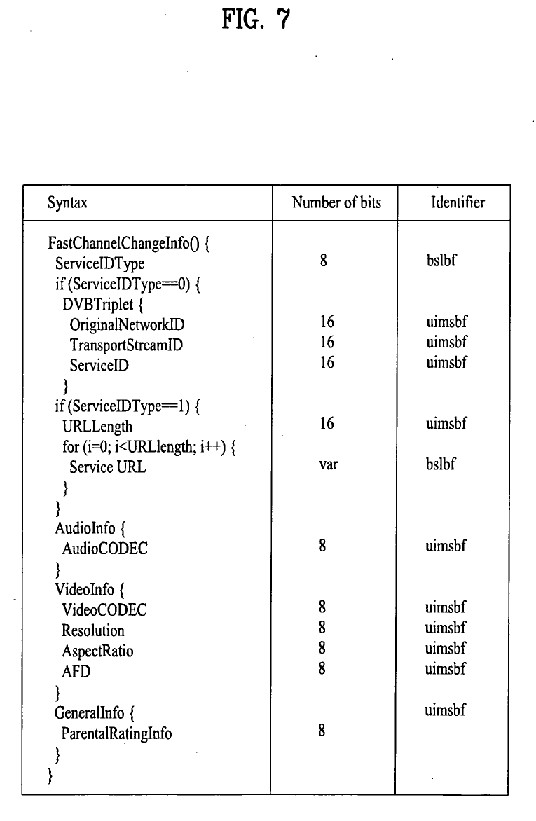

FIG. 5 illustrates a block diagram of FCC information structure according to an embodiment of the present invention, FIGS. 6A and 6B illustrates the XML schema of FCC information in FIG. 5, FIG. 7 illustrates the binary syntax of FCC information in FIG. 5. With references to FIG. 5, FIGS. 6A and 6B, and FIG. 7, the steps of generating FCC information by FCC information encoder will be described. The XML schema shown in FIGS. 6A and 6B is actually one XML schema. However, it is divided into two separate figures for illustrating purposes.

As illustrated in FIG. 5, FCC information includes ServiceID, AudioInfo, VideoInfo, and GeneralInfo, and the information mentioned are information needed when there is a channel change. It is possible to add or delete the information if necessary.

ServiceID described above includes the information identifying the internet broadcasting service, AudioInfo includes audio codec type information, VideoInfo includes video codec type, resolution, and aspect ratio information, and GeneralInfo includes rating information. Further, FCC information can be formulated in XML schema as illustrated in FIGS. 6A and 6B or formulated in binary format as illustrated in FIG. 7. The advantage of FCC information formulated in XML schema is that it is possible to transmit different information in different formats, whereas the advantage of FCC information formulated in binary format is that it is possible to transmit the compact data faster.

Moreover, to describe the binary format of the FCC information structure illustrated in FIG. 7, ServiceIPType field is used to identify the internet broadcast service, having DVB Triplet (for example: Original Network ID, Transport Stream ID, Service ID) or URL as components.

AudioCODEC field defines the audio codec information corresponding to the A/V stream of the internet broadcasting service, for example, if the field value is 0, it refers that the A/V stream audio codec type is PCM, if the field value is 1, it refers that the A/V stream audio codec type is MP3, and if the field value is 2, it refers that the A/V stream audio codec type is AAC.

VideoCODEC field defines the video codec information corresponding to the A/V stream of the internet broadcasting service, for example, if the field value is 0, it refers that the A/V stream video codec type is MPEG2 and if the field value is 2, it refers that the A/V stream video codec type is H.264.

Resolution field defines the resolution information corresponding to the A/V stream of the internet broadcast service, for example, if the field value is 0, it refers that the A/V stream resolution is 480i, if the filed value is 1, it refers that the A/V stream resolution is 480p, if the filed value is 2, it refers that the A/V stream resolution is 720p, if the filed value is 3, it refers that the A/V stream resolution is 1080i, and if the filed value is 4, it refers that the A/V stream resolution is 1080p.

AspectRatio field defines the aspect ratio information corresponding to the A/V stream of the internet broadcasting service, for example, if the field value is 0, it refers that the A/V aspect ratio is 16:9, if the field value is 1, it refers that the A/V aspect ratio is 4:3, if the field value is 2, it refers that the A/V aspect ratio is 14:8.

ParentRatingInfo field defines the rating information corresponding to the A/V stream of the internet broadcasting service, for example, if the field value is 0, it refers that the internet broadcasting service is a general broadcasting, if the field value is 1, then it refers that the internet broadcasting service needs parental guidance, and if the field value is 2, then it refers that the internet broadcasting service's rating is X-rated.

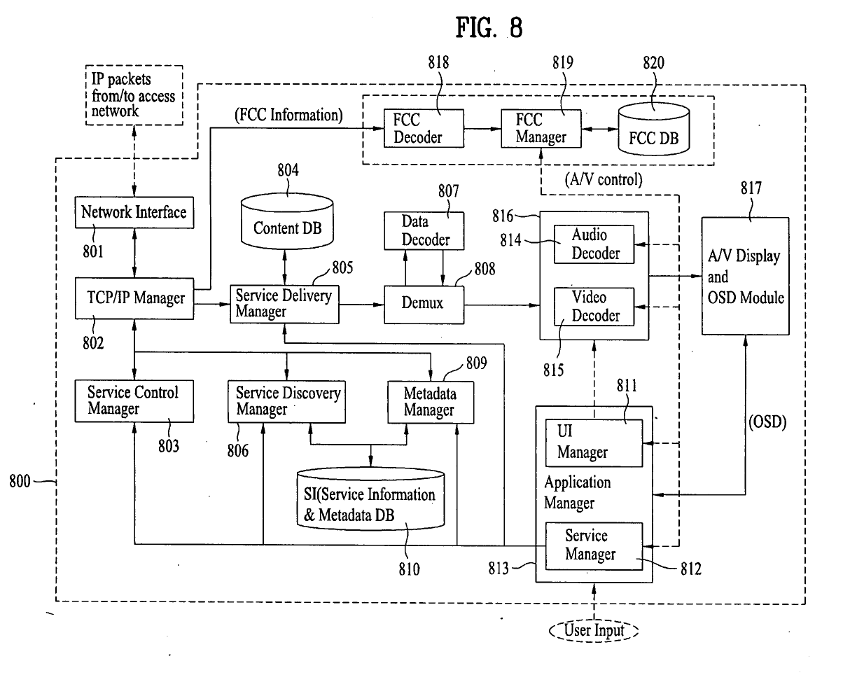

FIG. 8 illustrates a block diagram of IPTV Receiver configuration according to an embodiment of the present invention. With reference to FIG. 8, the steps of IPTV receiver implementing a fast channel change will be described. IPTV receiver illustrated in FIG. 8 can be integrated or correspond to the Client in FIG. 2 and FIG. 3.

IPTV receiver 800 according to an embodiment of the present invention may include a separate tuner to receive transmission from terrestrial broadcaster, cable broadcaster, or satellite broadcaster. For further explanation, the detailed description will focus on the contents received through internet network.

IPTV receiver 800 includes Network Interface 801, TCP/IP Manager 802, Service Delivery Manager 805, Demux (Demultiplexer) 808, Data Decoder 807, Decoder 816, Display (A/V Display & OSD Module) 817, Application Manager 813, Service Information (Hereinafter referred to SI) & Metadata DB 810, Service Discovery Manager 806, Service Control Manager 803, Metadata Manager 809, and Content DB 804. Further, in order to execute a fast channel change, which is the feature of the present invention, FCC Decoder 818, FCC Manager 819, and FCC DB 820 are included in IPTV receiver.

Network Interface 801 transmits and receives packet from and to the network. More specifically, Network Interface 801 receives service and contents from Service Provider through the network.

TCP/IP Manger 802 is engaged in packet transmission from the source to the destination, more specifically, transmits packet received by IPTV receiver 800 and transmits packet from IPTV receiver 800. Moreover, TCP/IP Manager 802 classifies the received packet into appropriate corresponding protocol and outputs the classified packet to Service Delivery Manager 805; Service Discovery Manager 806, Service Control Manager 803, and Metadata Manager 809.

Service Delivery Manager 805 is responsible for control of the service received. For example, RTP/RTCP is used in case of controlling a real-time streaming data. When transmitting real-time streaming data using RTP, Service Delivery Manager 805 parses the data packet according to RTP and transmits to Demux 808 or stores in Content DB 804 controlled by Service Manager 812. Service Delivery Manager 805 also provides feedback of the received network information to the server using RTCP.

Demux 808 demultiplexes the received audio, video, and Program Specific Information (Hereinafter referred to PSI) data, and transmits to Decoder 816 and Data Decoder 807 accordingly.

Data Decoder 807, for example, decodes the PSI. More specifically, Data Decoder 807 receives and decodes PSI section, Program and Service Information Protocol (PST) section, or DVB-SI section demultiplexed by Demux 808.

Data Decoder 807 also generates a database of the service information of the decoded sections received from the Demux 808 and stores the database in SI & Metadata DB 810.

Decoder 816 decodes the video data and audio data received from Demux 808. In order to decode the data, Decoder 816 includes Audio Decoder 814 and Video Decoder 815. The audio data, decoded by Audio Decoder 814 and the video data, decoded by Video Decoder 815 is provided to the customer through A/V Display and OSD Module 817.

Application Manager 813 manages the general status of IPTV receiver 800, provides user interface, and manages other managers. Thus, Application Manager 813 includes UI (User Interface) Manager 811 and Service Manager 812.

UI Manager 811 provides customer with Graphic User Interface (GUI) through On Screen Display (OSD) and receives a key input from the end user and executes to the receiver according to the key input. For example, if the end user instructs a channel change through key input, the key inputted request is transmitted to Service Manager 812.

Service Manager 812 controls managers involved in service, such as Service Delivery Manager 805, Service Discovery Manager 806, Service Control Manager 803, and Metadata Manager 809.

In addition, Service Manager 812 generates a Channel Map and selects a channel based on the key inputted request received from UI Manager 811 using the Channel Map. Further, Service Manager 812 receives service information of a channel from Data Decoder 807 and generates the selected A/V Packet Identifier (PID) in Demux 808.

Service Discovery Manager 805 provides the information regarding a service provider that provides a service. After receiving a channel change request from Service Manager 812, Service Discovery Manager 805 uses the above information to find the service.

Service Control Manager 803 is responsible for controlling and selecting a service. For example, if a customer selects Live Broadcasting service based on the existing broadcast method, IGMP or RTSP is used, and if a customer selects VOD, RTSP is used to select and control the service. The RTSP protocol provides trick mode regarding real-time streaming. Also, Service Control Manager 803 can manage and reset a session through IMC gateway using IP Multimedia Subsystem (IMS) and SIP. The above described protocol is one example of an embodiment and other protocols may be used depending upon different embodiments.

Metadata Manager 809 manages metadata related to service and stores the metadata service information in SI & Metadata DB 810.

SI & Metadata DB 810 stores decoded service information that Data Decoder 807 decoded. Also, SI & Metadata DB 810 stores metadata that Metadata Manager 809 manages and stores information needed to select the provider that is provided by the Discovery Manager 805. In addition, SI & Metadata DB. 810 can store set data regarding the system.

SI & Metadata DB 810 and Content DB 804 can each use NonVolatile RAM: NVRAM) or Flash memory to embody the storage process and use same storage area by dividing the area into two logically separated area.

Hereinafter, according to an embodiment of the present invention, a fast channel change method of the IPTV receiver will be described in detail.

The first embodiment stores FCC information regarding the internet broadcast service prior to booting the IPTV receiver or during the broadcasting and then when there is a channel change authorization, the IPTV receiver uses FCC information of the new channel to decode and display the A/V streams faster. In the second embodiment, when there is a channel change authorization, the IPTV receiver receives FCC information prior to receiving the A/V streams, then using FCC information to decode and display A/V streams faster.

The following explains the first embodiment in more detail.

According to the first embodiment of the present invention, a receiving unit of the IPTV receiver receives FCC information regarding the A/V streams of the associated internet broadcast service from at least one channel. It is possible to design the function of the storage according to FCC Decoder 818 illustrated in FIG. 8.

Further, a storage of the IPTV receiver stores the received FCC information associated with the internet broadcast service. It is possible to design the storage of the IPTV receiver according to FCC Manager 819 and FCC DB 820 illustrated in FIG. 8.

A display processor of the IPTV receiver is used to set the display of the A/V streams of the new channel associated with the internet broadcast service using pre-stored FCC information of the new channel. It is possible to design the display processor of the IPTV receiver according to Decoder 816, Application Manager 813, and A/V Display and OSD Module 817 as illustrated in FIG. 8. A/V Display and OSD Module 817 can include VDP.

After setting the display of the A/V streams, a receiving unit of the IPTV receiver further receives the A/V streams of the internet broadcast service of the new channel. It is possible to design the function of the second receiving unit according to Network Interface 801, TCP/IP Manager 802, Service Delivery Manager 805, and Demx 808 illustrated in FIG. 8.

The control unit of the IPTV receiver controls the display of A/V streams using the result of the setting unit mentioned above. The control unit of the IPTV receiver can be designed according to Decoder 816, Application Manager 813, and A/V. Display and OSD Module 817 as illustrated in FIG. 8.

The following explains the second embodiment in more detail.

According to the second embodiment of the present invention, a receiving unit of the IPTV receiver receives the FCC information regarding the A/V streams of the new channel corresponding to the internet broadcast service. The function of the receiving unit can be performed by designing FCC Decoder 818 accordingly as illustrated in FIG. 8.

A display processor of the IPTV receiver is used to set the display of the A/V streams of the new channel of the internet broadcast service using the received display information of the new channel. It is possible to design the display processor of the IPTV receiver according to Decoder 816, Application Manager 813, and A/V Display and OSD Module 817 as illustrated in FIG. 8. A/V Display and OSD Module 817 can include VDP.

After setting the display of A/V streams, the receiving unit of the IPTV receiver further receives the A/V streams of the internet broadcast service of the new channel. It is possible to design the function of the second receiving module according to Network Interface 801, TCP/IP Manager 802, Service Delivery Manager 805, and Demx 808 illustrated in FIG. 8.

The control unit of the IPTV receiver controls the display of the A/V streams using the result of the setting unit mentioned above. The control unit of the IPTV receiver can be designed according to Decoder 816, Application Manager 813, and A/V Display and OSD Module 817 as illustrated in FIG. 8.

FCC information, for example, may include information of the identification, audio codec type, video code type, resolution, aspect ratio, and rating of the internet broadcast service.

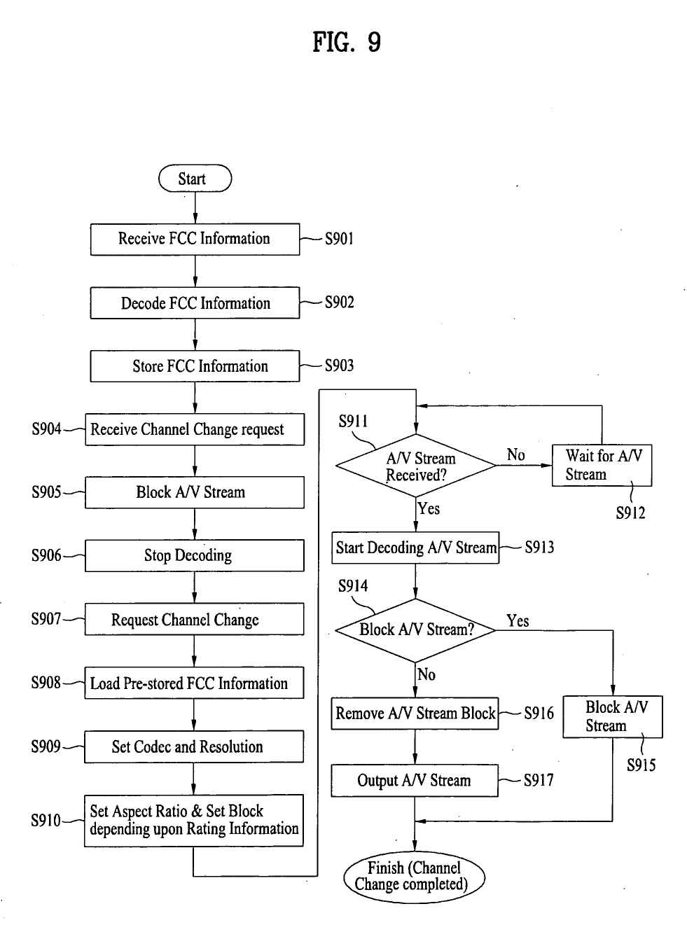

FIG. 9 is a flowchart illustrating a method for changing channel of the IPTV receiver according to the first embodiment of the present invention. With reference to FIG. 9, the following explains the method of channel change according to the first embodiment of the present invention.

First, IPTV receiver receives the FCC information of the A/V streams of the internet broadcast service of at least one channel S901. FCC Decoder of IPTV receiver decodes the FCC information above S902, and then FCC Manager stores the decoded FCC information by storing the associated internet broadcast service into FCC DB S903.

If a channel change request is received from an end user S904, VDP blocks A/V streams S905. In addition, A/V Decoder stops decoding A/V streams S906, and Application Manager requests a channel change to FCC Manager, responsible for managing the FCC information S907. Further, FCC Manager loads FCC information of A/V streams of the internet broadcasting service of the new channel stored in FCC DB S908. Moreover, A/V Decoder is configured to manage the codec and resolution information of FCC information of A/V streams S909. VDP is configured to manage A/V streams according to the aspect ratio and rating information of FCC information S910.

IPTV receiver, then, determines whether the A/V streams of the new channel are received or not S911. Upon determination S911, if no A/V streams are received, IPTV receiver will wait for the A/V streams to be received S912. If the A/V streams are received S911, A/V Decoder decodes A/V streams according to the newly received codec and resolution information S913. FCC Manager then determines whether A/V streams should be blocked or not, according to the rating information of the A/V streams associated with an internet broadcast service of the new channel S914. If FCC Manager determined to block the A/V streams, VDP will block A/V streams S915. If FCC Manager determined not to block the A/V streams, VDP removes the block on the A/V streams S916. Then VDP outputs the A/V streams associated with the internet broadcast service S917.

To summarize the above steps of a method of changing a channel of an IPTV receiver according to the first embodiment of the present invention, the FCC information of A/V streams associated with the internet broadcasting service of at least one channel is received by the IPTV receiver S901.

Then, the IPTV receiver stores FCC information by storing FCC information with the associated internet broadcasting service S902, S903.

Next, the IPTV receiver sets the display of A/V streams associated with the internet broadcasting service using pre-stored display information of the new channel S904, S905, S906, S907, S908, S909, S910.

During the steps of setting the display using pre-stored display information as mentioned above, the steps may also include determining the configuration of the codec and resolution information of A/V Decoder of the IPTV receiver, and determining the configuration of the aspect ratio and blocking information of VDP of the IPTV receiver.

After setting the display, the IPTV receiver receives the A/V streams of the associated internet broadcast service of the new channel S911, S912.

Then, the IPTV receiver, using the set configuration, controls to display the received A/V streams S913, S914, S915, S916, S917.

During the steps of configuring A/V Decoder, the steps may also include decoding the A/V streams, and displaying the decoded A/V streams according to VDP.

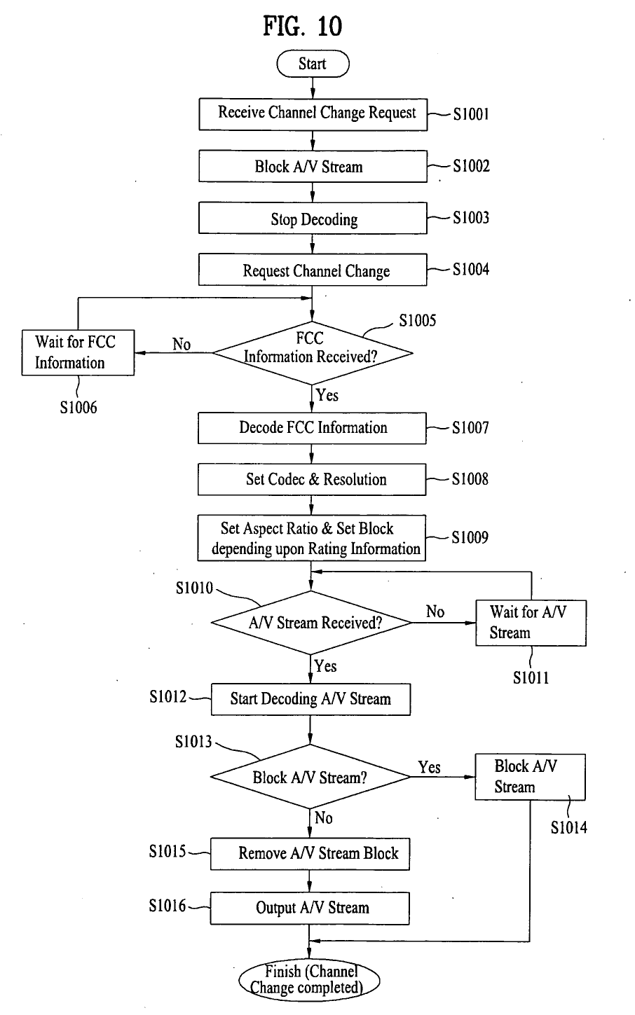

FIG. 10 is a flowchart illustrating a method for changing channel of an IPTV receiver according to the second embodiment of the present invention. With reference to FIG. 10, the following explains the method of a channel change according to the second embodiment of the present invention.

If a channel change request is inputted S1001, then VDP blocks the A/V streams S1002. In addition, A/V Decoder stops decoding the A/V streams S1003 and Application Manager requests for a channel change to Network Interface unit where the FCC information is received S1004. Network Interface unit where the FCC information is received, then determines whether the FCC information is received or not S1005. If the FCC information is not received, the IPTV receiver waits for the FCC information S1006, and if the FCC information is received, FCC Decoder decodes the FCC information received through Network Interface unit S1007. A/V Decoder is then configured to manage the A/V streams according to the codec and resolution information of the decoded FCC information S1008. VDP is configured to manage the A/V streams according to the aspect ratio and rating information of the decoded FCC information S1009.

Then, the IPTV receiver determines whether the A/V streams of the new channel are received or not S1010. If the A/V streams are not received, the IPTV receiver waits for the A/V streams S1011. If the A/V streams are received, A/V Decoder decodes the A/V streams according to the newly set codec and resolution information S1012. Also, the FCC Manager determines whether to block the A/V streams according to the newly set rating information of the A/V streams associated with an internet broadcast service of the new channel S1013. If the A/V streams need to be blocked, VDP will continuously block A/V streams S1014. If the A/V streams do not need to be blocked, VDP removes the block on the A/V streams S1015. VDP outputs the display of the A/V stream corresponding to the internet broadcasting service of the new channel S1016.

To summarize the above steps of a method of changing a channel of the IPTV receiver according to the second embodiment of the present invention, first, a channel change request is inputted, and then the FCC information of the A/V streams associated with the internet broadcast service of the new channel is received S1001, S1002, S1003, S1004, S1005, S1006.

Then IPTV Receiver, using FCC information received, configures to set the display of the A/V stream corresponding to the internet broadcasting service of the new channel S1007, S1008, S1009.

During the steps of setting the display of the A/V streams using the display information, the steps may also include determining the codec and resolution configuration of the A/V Decoder of the IPTV receiver, and determining the aspect ratio and blocking information of VDP of the IPTV receiver.

IPTV receiver, after setting the display of the A/V streams, receives the A/V streams associated with the internet broadcasting service of the new channel S1010, S1011.

Next, IPTV receiver, using the display and codec information, displays the A/V streams received S1012, S1013, S1014, S1015, S1016.

During the steps of configuring A/V Decoder, the steps may also include decoding the A/V streams, and displaying the decoded the A/V streams according to VDP.

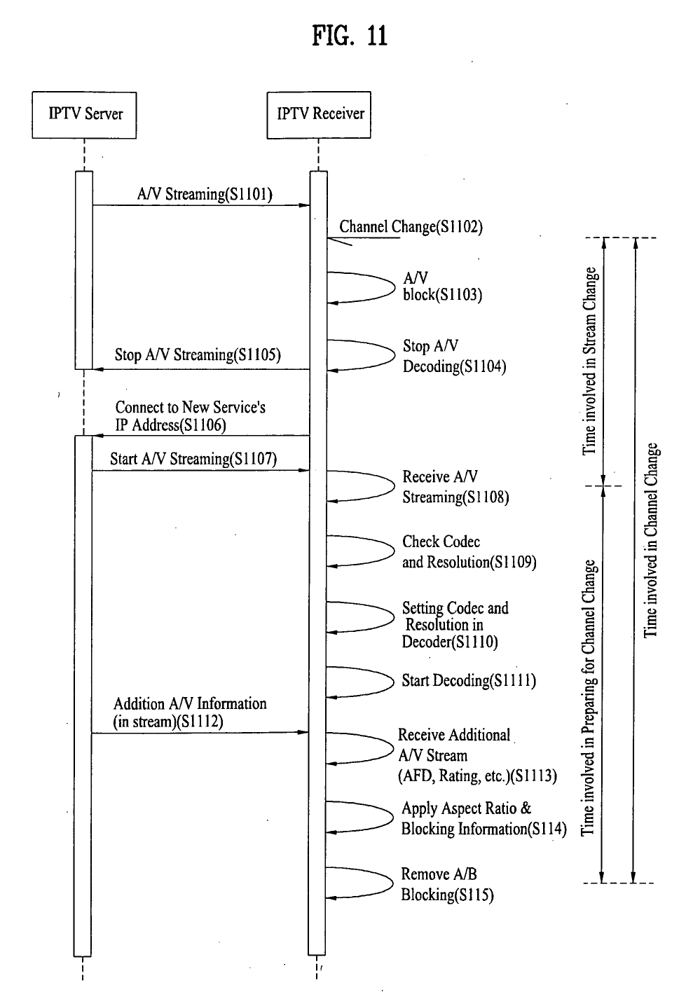

FIG. 11 is a flowchart illustrating the general steps in changing channel of an IPTV server and an IPTV receiver. With reference to FIG. 11, steps of changing a channel of the IPTV server and the IPTV receiver will be described in detail.

As illustrated in FIG. 11, the IPTV server transmits the A/V streams to the IPTV receiver S1101, and when a channel change is authorized by the IPTV receiver S1102, the IPTV receiver blocks the A/V streams S1103. IPTV receiver also stops decoding the A/V streams S1104. Then, the IPTV receiver requests to the IPTV server to stop transmitting the A/V streams S1105.

IPTV receiver connects to the provided IP address that associates with the internet broadcasting service of the new channel S1106. Then, the IPTV server starts transmitting the A/V streams S1107. The IPTV receiver receives the streaming S1108, and then the IPTV receiver checks the codec and resolution information of the A/V streams S1109. A/V Decoder in the IPTV receiver sets the display of the A/V streams using the checked codec and resolution information of the A/V streams S1110. IPTV receiver decodes the A/V streams S1111. IPTV receiver receives additional information regarding the A/V streams from the IPTV server S1112, and checks AFD, rating, and other A/V information using the additional information regarding the A/V streams received from the IPTV server S1113. The IPTV server then configures VDP using the checked AFD, rating, and other A/V information, for example, controlling the aspect ratio and blocking information S1114. IPTV receiver then removes block of the A/V streams using the set information S1115.

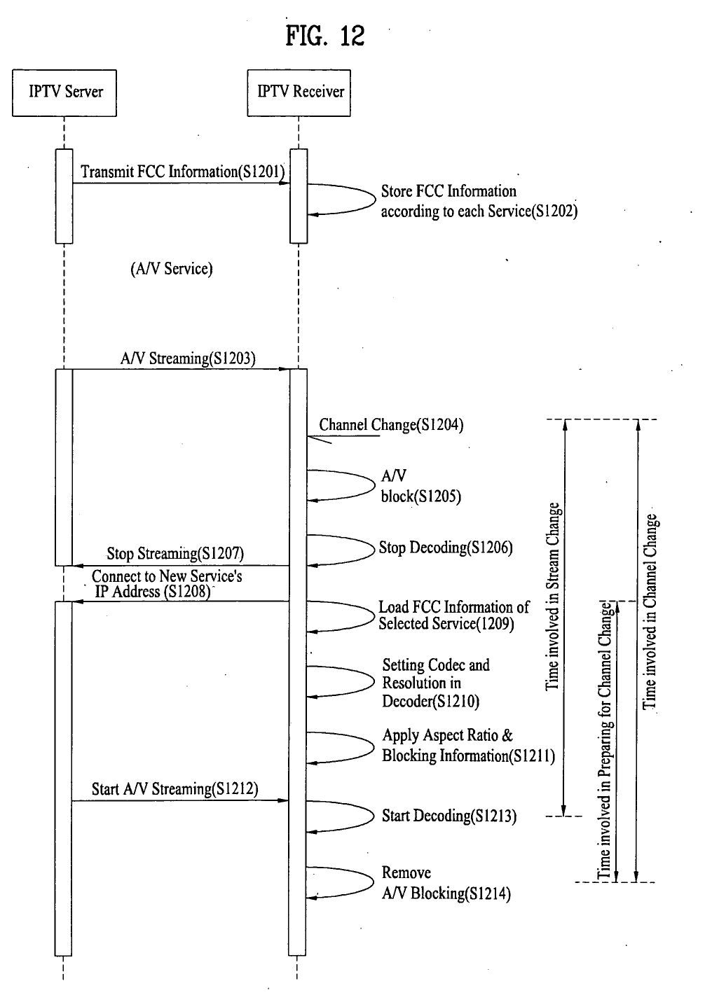

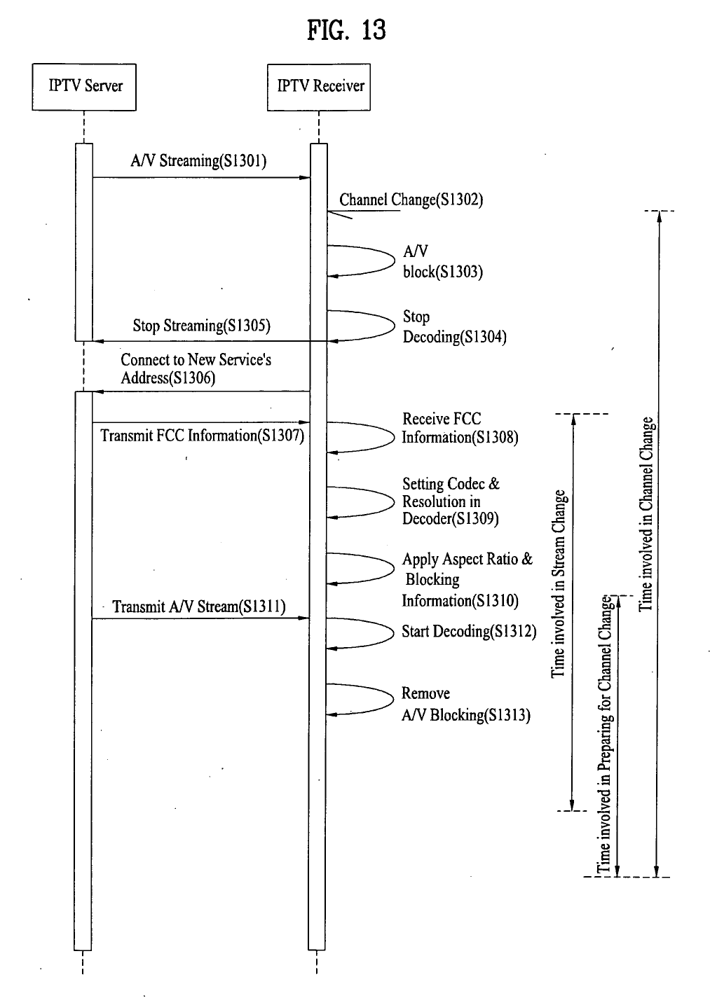

FIG. 12 is a flowchart illustrating the steps in changing channel of the IPTV server and the IPTV receiver according to the first embodiment of the present invention and FIG. 13 is a flowchart illustrating the steps in changing channel of the IPTV server and the IPTV receiver according to the second embodiment of the present invention. With reference to FIG. 12 and FIG. 13, the description below illustrates that the time it takes to change channel in the first and second embodiment of the present invention is much faster than the general steps of changing channel illustrated in FIG. 11.

As illustrated in FIG. 12, the IPTV server transmits the FCC information to the IPTV receiver S1201. The IPTV receiver stores the FCC information associated with the internet broadcast service of at least one channel S1202. The IPTV server transmits the A/V streams to the IPTV receiver S1203. When the IPTV receiver receives an authorized channel change request S1204, the IPTV receiver blocks the A/V streams S1205. In addition, the IPTV receiver stops decoding the A/V streams S1206. Then, the IPTV receiver requests to the IPTV server to stop the A/V stream transmission S1207.

The IPTV receiver connects to a provided IP address associated with the internet broadcasting service of the new channel S1208. The IPTV receiver, using the pre-stored FCC information, loads the FCC information of the new channel S1209. The IPTV receiver, using the codec and resolution information from the FCC information previously loaded, sets A/V Decoder S1210. The IPTV receiver then sets VDP using the aspect ratio and rating information from the FCC information previously loaded S1211.

Next, the IPTV receiver starts receiving the A/V streams S1212, decodes the A/V streams according to the newly set A/V Decoder function S1213, and removes the A/V streams block using the newly set VDP information S1214.

As illustrated in FIG. 13, the timeline of the second embodiment of the present invention is shown, where the IPTV server transmits the A/V streams to the IPTV receiver S1301. When IPTV server receives an authorized change of channel request S1302, the IPTV receiver blocks the A/V streams S1303. The IPTV receiver also stops decoding the A/V streams S1304. Then the IPTV receiver requests to the IPTV server to stop transmitting the A/V streams S1305.

The IPTV receiver connects to a provided IP address associated with the internet broadcast service of the new channel S1306. The IPTV server then transmits the FCC information associated with the internet broadcasting service of the new channel to the IPTV receiver S1307. The IPTV receiver receives the FCC information S1308, and sets A/V Decoder using the codec and the resolution information from the FCC information received S1309. The IPTV receiver also configures VDP using the aspect ratio and the rating information from the FCC information received S1310.

The IPTV receiver starts receiving the A/V streams S1311, decodes the A/V streams according to the newly set A/V Decoder configuration S1312, and removes the block on the A/V streams according to the newly set VDP configuration S1313.

As a result, comparing the timeline illustrated in the right side of FIG. 11, FIG. 12, and FIG. 13, it is evident that during the process of the IPTV channel change, the time involved in preparing for displaying the A/V streams of the changed channel has been significantly reduced in FIG. 12 and FIG. 13.

As mentioned above, the FCC information may include information regarding the internet broadcast service that includes identifying the internet broadcasting service, audio codec type, video codec type, resolution, aspect ratio, and rating. The FCC information can be transmitted in binary format or XML format.

Both method claims and apparatus claims are described in the present invention and it can supplementary applied if needed.

Another method claim of the present invention may be recorded in a computer medium using computer program commands. The commands, data file, and data structure of the computer program that enables to record in a computer medium can be included separately or in combination. The computer program commands can be specially designed and configured, or it can be published to a person skilled in computer software and be used. Examples of possible recorded computer medium can include storage devices that can store program commands and includes hardware configuration, such as hard disk, floppy disk or magnetic media, CD-ROM, DVD or optical media, ROM, RAM, or flash memory. The computer program command can be machine language generated using a complier, but it can also include high level program code using an interpreter. The hardware device can include more than one software module to execute the program.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of changing a channel in an Internet Protocol Television (IPTV) receiver, the method comprising:
receiving Fast Channel Change (FCC) information of Audio/Video (A/V) streams associated with an internet broadcast service of at least one channel, the FCC information comprising display and codec information;
pre-storing the FCC information of the A/V streams in a storage;
setting display configuration for a new channel using the pre-stored display information when a channel change request is received from an end user, the new channel being one of the at least one channel;
setting codec configuration for the new channel using the pre-stored codec information;
receiving A/V streams associated with an internet broadcast service of the new channel after the display and codec configurations are set; and
displaying the A/V streams of the new channel according to the display and codec configuration.

2. The method of claim 1, wherein the display information comprises information identifying service identification, resolution, aspect ratio, and rating information.

3. The method of claim 1, wherein the codec information comprises information identifying audio codec type and video codec type.

4. The method of claim 1, wherein setting the display configuration comprises:
determining a resolution of a decoder using the pre-stored display information;
determining an aspect ratio of a Video Display Process (VDP) using the pre-stored display information; and
determining blocking information of the VDP using the pre-stored display information.

5. The method of claim 4, wherein the blocking information is determined by a rating information of the A/V streams associated with an internet broadcast service of a new channel;

6. The method of claim 1, wherein setting the codec configuration comprises determining an audio codec type and a video codec type of a decoder using the pre-stored codec information.

7. The method of claim 1, wherein the FCC information is transmitted in XML or binary format.

8. A method of changing a channel in an Internet Protocol Television (IPTV) receiver, the method comprising:
receiving Fast Channel Change (FCC) information of Audio/Video (A/V) streams associated with an internet broadcast service of a new channel when a channel change request is received from an end user, the FCC information comprising display and codec information;
setting display configuration for the new channel using the display information,
setting codec configuration for the new channel using the codec information;
receiving the A/V streams associated with the internet broadcast service of the new channel after the display and codec configurations are set; and
displaying the A/V streams of the new channel according to the display and codec configuration.

9. The method of claim 8, wherein the display information comprises information identifying service identification, resolution, aspect ratio, and rating information.

10. The method of claim 8, wherein the codec information comprises information identifying audio codec type and video codec type;

11. The method of claim 8, wherein setting the display configuration comprises:
determining a resolution of a decoder using the display information;
determining an aspect ratio of an Video Display Process (VDP) using the display information; and
determining blocking information of the VDP using the display information.

12. The method of claim 11, wherein the blocking information is determined by the rating information of the A/V streams associated with an internet broadcast service of a new channel;

13. The method of claim 8, wherein setting the codec configuration comprises determining an audio codec type and a video codec type of a decoder using the codec information.

14. The method of claim 8, wherein the FCC information is transmitted in XML or binary format.

15. An Internet Protocol Television (IPTV) receiver comprising:
a receiving unit for receiving Fast Channel Change (FCC) information of Audio/Video (A/V) streams associated with an internet broadcast service of at least one channel, the FCC information comprising display information and codec information of the A/V streams;
a storage for pre-storing the display and codec information;
a display processor for processing the A/V streams, wherein a display configuration of the display processor for a new channel is set using the pre-stored display information when a channel change request is received from an end user, the new channel being one of the at least one channel;
a decoder for decoding the A/V streams, wherein a codec configuration of the decoder for the new channel is set using the pre-stored codec information when the channel change request is received from the end user, wherein the receiving unit further receives A/V streams of associated with an internet broadcast service of the new channel after the display and codec configurations are set; and
a display for displaying the AV streams of the new channel according to the display and codec configurations.

16. An Internet Protocol Television (IPTV) receiver comprising:
a receiving unit for receiving Fast Channel Change (FCC) information of Audio/Video (A/V) streams associated with an internet broadcast service of a new channel when a channel change is requested from an end user, the FCC information comprising display information and codec information of the A/V streams;
a display processor for processing the A/V streams, wherein a display configuration of the display processor for a new channel is set using the display information;
a decoder for decoding the A/V streams, wherein a codec configuration of the decoder for the new channel is set using the codec information, wherein the receiving unit further receives A/V streams of associated with an internet broadcast service of the new channel after the display and codec configurations are set; and
a display for displaying the AV streams of the new channel according to the display and codec configurations.
